(19) United States
(12) Patent Application Publication
(10) Pub. No.: US 2010/0332310 A1
(43) Pub. Date: Dec. 30, 2010

(54) SYSTEMS AND METHODS FOR ADVERTISING AND DISTRIBUTING PRIZES USING LOCATION-BASED SERVICES

(76) Inventors: Joseph Russell, Victoria (AU); Samuel Russell, Victoria (AU)

Correspondence Address: KLARQUIST SPARKMAN, LLP, 121 SW SALMON STREET, SUITE 1600, PORTLAND, OR, 97204, US

(21) Appl. No.: 12/823,045

(22) Filed: Jun. 24, 2010

Related U.S. Application Data
(60) Provisional application No. 61/269,567, filed on Jun. 25, 2009.

(51) Int. Cl. G06Q 30/00; G06Q 50/00; H04W 64/00; H04W 4/14; G06F 3/048

(52) U.S. Cl. 705/14.36; 455/456.1; 455/466; 715/810

(57) ABSTRACT

The system and methods include delivering a prize to a mobile device based upon the geographic location of the mobile device. The system can include a registration interface for registering a plurality of mobile devices with the system and a registration interface for registering a plurality of clients with the system. A prize designation interface can associated one or more prizes with a specific geographic location. The prizes can be delivered to registered mobile devices when it is determined that the mobile devices are in the specific geographic locations associated with the prizes.

### CROSS REFERENCE TO RELATED APPLICATION

This application claims the benefit of U.S. Provisional Application No. 61/269,567, filed on Jun. 25, 2009. The entire disclosure of U.S. Provisional Application No. 61/269,567 is considered to be part of the disclosure of the following application and is hereby incorporated by reference.

### FIELD

The present invention is in the field of location-based services. More particularly, the present invention is in the field of location-based applications for mobile devices.

### BACKGROUND

Geocaching is a treasure hunt style activity that usually involves a user following a series of instructions and GPS coordinates in order to find a “geocache.” For example, a geocache can be a small object containing a record of the names of all the people who have found it. Since geocaching requires the deposit of a physical object at a designated location, it is not well-suited for activities where many different users are seeking to collect and use the deposited item.

Various methods of distributing advertisements based on the location of the user have been developed. For example, the following patent publications, U.S. Patent Publication Nos. 2007/0287437, 2006/0116819, 2008/0227467, 2008/0297409 and 2009/0258656, each of which is incorporated by reference herein in its entirety, may contain descriptions of sending information or advertisements to mobile users depending on their location. However, each of these systems has various shortcomings and does not offer the advantages of the system disclosed in this application.

### SUMMARY OF THE INVENTION

The systems and methods described herein (the various embodiments of which are sometimes referred to herein as DreamWalk or the DreamWalk systems and/or methods) allow clients such as advertisers and companies to promote and distribute prizes such as free giveaways to mobile users. The DreamWalk systems and methods can also enable clients to give away free products to users of the DreamWalk systems and methods (e.g., mobile application) when they are in specific GPS locations.

In some embodiments, the DreamWalk systems and methods comprise a web interface and application for mobile devices that allows clients, including businesses, advertisers and individuals, to place free (or otherwise discounted) products and samples onto a digital prize map for mobile device users to find and collect using a map-based and/or geo-locating system, such as GPS. Such products are referred to herein as prizes. The location and/or identity of these products can be indicated, for example, by graphic icons on the map.

A GPS based mapping or geo-tagging application to promote and distribute giveaways, prizes and samples using a process, as described herein, has numerous advantages over the prior art. For example, a self-service, web-based user interface for adding prizes to the application's map can allow clients to tailor their giveaways to local markets. Likewise, the ability to collect virtual representations of prizes from GPS map locations and store them for later redemption for real life products is a significant advancement over the prior art.

In one embodiment, a system for delivering a prize to a mobile device is provided. The system comprises a registration interface for registering a plurality of mobile devices with the system (e.g., using a web page interface as shown in FIGS. 1-2). The system can also comprise a registration interface for registering a plurality of clients with the system (e.g., using a web page interface as shown in FIGS. 1-2). The system can also comprise a prize designation interface through which each of the plurality of clients can designate one or more prizes (e.g., using a web page interface as shown in FIG. 2). Each prize can be associated with a specific geographic location (e.g., as shown in 3). The system can also comprise a geographic location receiving device (e.g., a server and/or application running on the server) to receive information relating to the geographic location of the registered mobile devices. The system can also comprise a delivery device (e.g., a server) for delivering the prize to one of the registered mobile devices when that mobile device is located within a predetermined radius of the specific geographic location associated with the delivered prize. The location of the mobile device can be determined using global positioning system (GPS) information.

In specific implementations, the prize comprises a redeemable prize that can be presented to the designating client to receive an item of monetary value (such as a product or service, or a discount on a product or service). The prize can be presented to the designating client by, for example, one of (1) in store presentation, (2) e-mail, (3) SMS text, or (4) web-link.

In specific implementations, the plurality of clients can designate one or more collection prize, wherein a plurality of prizes must be delivered to one registered mobile device prior to receiving a collection prize, the collection prize being redeemable upon presentation to the designating client to receive an item of monetary value. The collection prize can be presented to the designating client by one of (1) in store presentation, (2) e-mail, (3) SMS text, or (4) web-link. The collection prize can comprise a collection of stamp prizes or a collection of treasure hunt prizes. The collection prize can also comprise one or more clues that can either be used to locate and/or collect a prize.

In other specific implementations, a method for delivering a redeemable prize to a mobile device using a prize delivery system is provided. The method can comprise registering a plurality of mobile devices with the system; registering a plurality of clients with the system; associating a plurality of redeemable prizes with one or more clients, each redeemable prize being associated with a specific geographic location; determining when a registered mobile device is within a predetermined radius of the specific geographic location associated with one or more of the redeemable prizes; and delivering the redeemable prize associated with the specific geographic location when the registered mobile device is within the predetermined radius of the specific geographic location associated with that redeemable prize.

In other specific implementations, a computer-readable storage medium storing computer-executable instructions for causing a computer to perform a method for delivering a redeemable prize to a mobile device using a prize delivery system is provided. The method can comprise registering a plurality of mobile devices with the system; registering a plurality of clients with the system; associating a plurality of redeemable prizes with one or more clients, each redeemable prize being associated with a specific geographic location; determining when a registered mobile device is within a predetermined radius of the specific geographic location associated with one or more of the redeemable prizes; and delivering the redeemable prize associated with the specific geographic location when the registered mobile device is within the predetermined radius of the specific geographic location associated with that redeemable prize.

### BRIEF DESCRIPTION OF THE DRAWINGS

FIG. 1 illustrates an exemplary website interface in which clients or users can sign up to the DreamWalk system.

FIG. 2 illustrates a website interface where a client can enter details about its business and about its ad campaign.

FIG. 3 illustrates a website interface where a client can enter details about its business and about its ad campaign, including the location, type, and number of prizes.

FIG. 4 illustrates a website interface where a client can access account information, including a number of prizes retrieved and their locations.

FIG. 5 illustrates a screenshot of a DreamWalk mobile application showing a map and the location of various client-sponsored prizes.

FIG. 6 illustrates a screenshot of a DreamWalk mobile application indicating that a user has moved close enough to the GPS location of a prize (as determined by the preselected/predetermined radius), displaying the prize image for that prize on the mobile device screen, and requesting whether the user would like to “pick up” the prize.

FIG. 7 illustrates an administration control page, including a universal prize point cost factor that can be set by administration in the administration control page.

FIG. 8 illustrates an administration campaign approval page through which uploaded prizes can be reviewed by a DreamWalk administration for approval prior to being activated within the system.

FIG. 9 illustrates an exemplary site map of an embodiment of a DreamWalk website.

FIGS. 10A-10C illustrate an embodiment of an application (e.g., a DreamWalk mobile application) that can run on a mobile phone device in accordance with the systems and methods described herein.

### DETAILED DESCRIPTION OF THE INVENTION

The following detailed description includes references to the accompanying figures, which form a part of the detailed description. The figures, which generally comprise screenshots of web pages or handheld devices, illustrate example embodiments in which the subject matter may be practiced. These embodiments, which are also referred to herein as “examples,” are described in enough detail to enable those skilled in the art to practice the subject matter. The embodiments may be combined, other embodiments may be used, or structural, logical, and electrical changes may be made without departing from the scope of the present subject matter. The following detailed description is, therefore, not to be taken in a limiting sense.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” and “achieve” to describe the disclosed methods. These terms are high-level abstractions of the actual operations that are performed. The actual operations that correspond to these terms may vary depending on the particular implementation and are readily discernible by one of ordinary skill in the art.

As used herein, the terms “DreamWalk” and “DreamWalk system” refer to the systems and methods described in the embodiments herein. These terms are not intended to limit the systems or methods described herein in any way.

As used herein, the term “client” refers to a company, group, or individual that uses a system to place prizes or advertisements in the manner described herein. As used herein, a “user” is any person that accesses the system to identify prizes or advertisements placed by a client.

As used herein, “prize” or “prizes” refer to any item representative of an item of value (e.g., an item of monetary, collectability, or other value) that can be associated with a particular geographic location for “collection” by a user of the DreamWalk systems and methods described herein. In some instances, readily determinable in the instant disclosure, the term “prize” or “prizes” may refer to the actual item of value, which the “representative” prize can be used to obtain, receive, and/or collect.

The systems and methods described herein include an application for use with GPS-enabled mobile devices or mobile devices enabled with other navigation or geo-locating devices. As described in more detail below, the systems and methods disclosed herein can utilize geo-locating technology that is commonly available for use with various mobile devices, including for example, cell phones, mobile internet devices (MID), and ultra-mobile portable PCs (UMPC). As described in U.S. Patent No. 2009/0258656, which has been incorporated herein by reference, such devices are often location-aware, in that they include a GPS-based system or can otherwise determine their approximate location by other means such as detecting WiFi or cell IDs which can then be used by a server in communication with the device to ascertain the approximate location of the user.

The systems and methods described herein generally allows clients (or other individuals) to place prizes, giveaways and free samples on a virtual prize map via the DreamWalk website, and mobile device users to collect them using their GPS location. Unlike geocaching, however, the DreamWalk systems and methods described herein do not require knowing or finding specific GPS coordinates of the user and/or prizes. Instead, prizes can be located by simply moving to the GPS locations of prize icons on the DreamWalk map. In addition, geocaches are generally items that are physically located at GPS coordinates for users to physically locate. In at least some embodiments of the DreamWalk systems and methods disclosed herein, DreamWalk prizes can be electronic information that can be virtually collected and redeemed for real items of monetary or other value. This can provide a great benefit to clients, since they can add prizes to the DreamWalk system (e.g., a DreamWalk map) without having to physically place prizes at a particular location. Instead, the “placement” of prizes can be done virtually (e.g., via designating electronic information representative of a location of a prize), eliminating the physical work of hiding, depositing, or delivering geocaches. Also, the prizes available to DreamWalk users are unlike geocaches in that they can be free products (i.e., prizes) that have been added by business, advertisers, and individuals. DreamWalk prizes can be kept by users and the quantity of prizes available can be set by the client who added them.

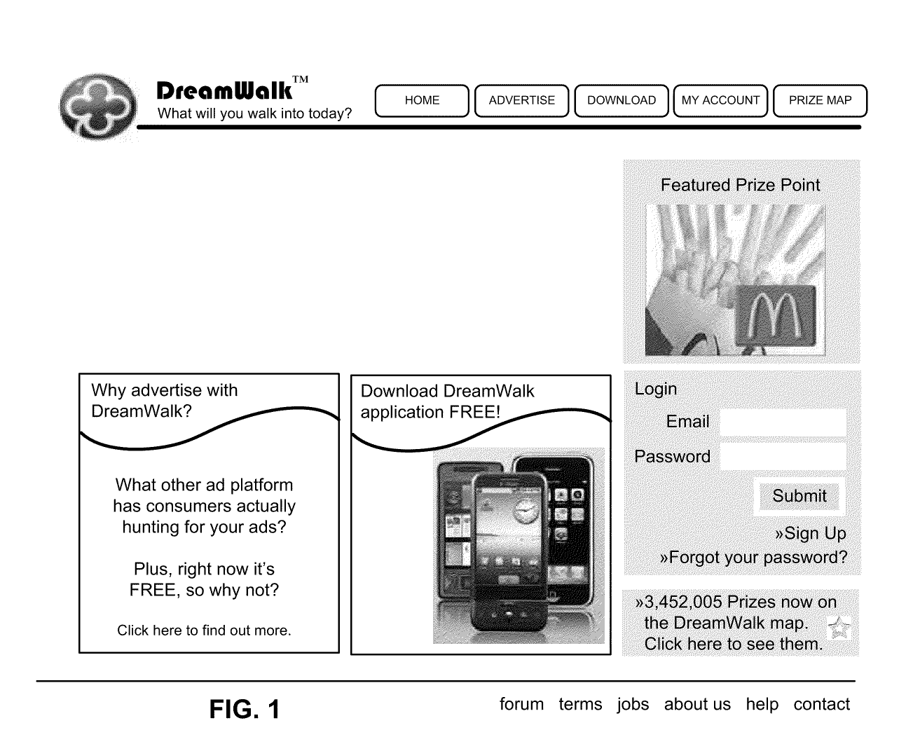

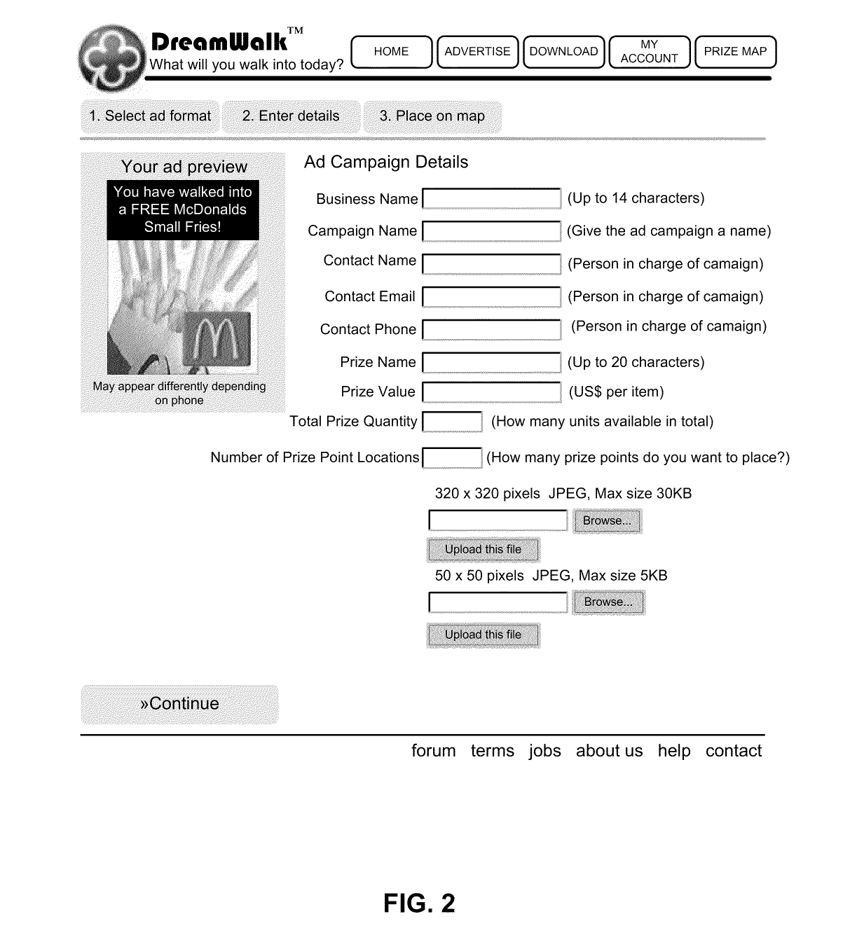

Preferably, clients must create an account on the DreamWalk system (e.g., by accessing a DreamWalk website) in order to upload prizes to the map. FIG. 1 illustrates an exemplary website interface in which clients or users can sign up to the DreamWalk system. FIG. 2 illustrates a website interface where a client can enter details about its business and about its ad campaign. After entering their details, the client can be asked to verify their email address by clicking a verification link in an email that is automatically sent to them from DreamWalk.

Once logged in, clients can upload prizes to the map for users to collect. Clients may enter a variety of different prizes. For example, in one embodiment, a client is given the option of the entering an “instant prize,” “collector stamps,” or “treasure hunt clues.” Each of these types of prizes is discussed in more detail below.

### Instant Prizes

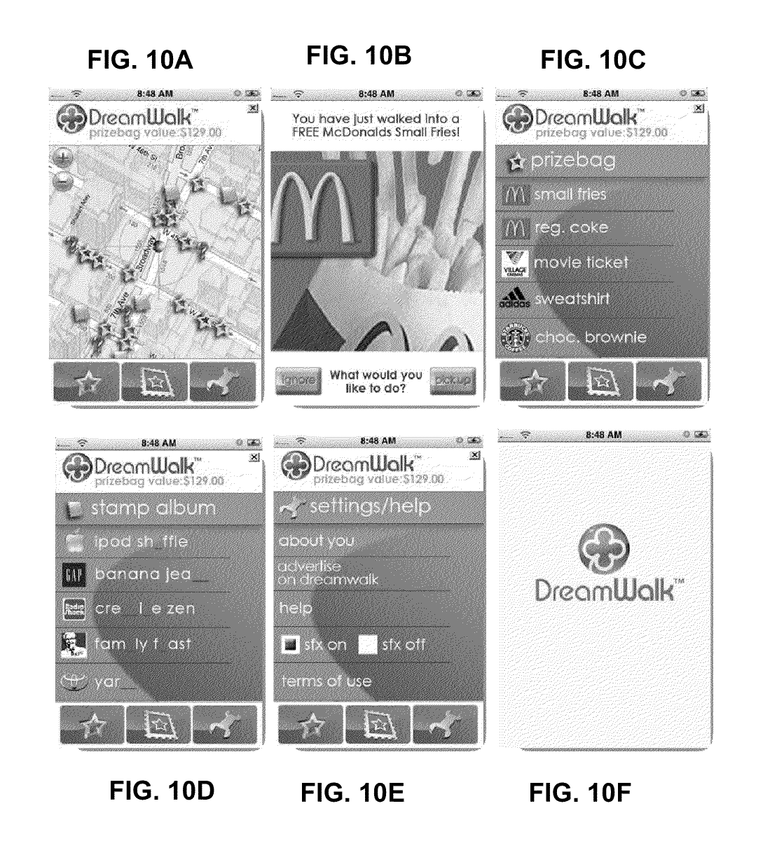

When a user “walks into” an instant prize (e.g., physically enters the geographically designated area of the prize), an ad for the particular brand or product can be displayed on their mobile phone and they can be asked whether they would like to ‘pick up’ the free item or ignore it. If they pick it up, the prize can be stored in their DreamWalk Prize Bag (FIG. 10C). They can then access it at any time and redeem it in one of the manners described above at the applicable store or business.

### Collector Stamps

This type of prize requires the user to collect a number of stamps from different map locations in order to claim a prize. The type of stamps that are collected can vary and a “set” of stamps can be collected to complete or establish a collection, which can entitle the user to obtain a prize. For example, stamps may contain a letter of the alphabet so that when put together, they spell out a word to win a prize. As shown in FIG. 10D, stamps can be collected and put into the user's Stamp Album which enables them to keep track of prize stamps they are collecting. As shown in FIG. 10D, for example, various collection prizes are being sought by the user, with each of these prizes currently missing letters (e.g., stamps). Thus, the user has collected “IPOD SH_FFLE,” but is missing the letter “U” from the iPod shuffle prize. Once the user locates the “U,” the user may be entitled to the prize (e.g., an iPod shuffle) or the user may be entitled to obtain a chance at winning the prize (such as by entry into a sweepstake, etc.). The collector stamp campaign can comprise any number of stamps and can display the client's prize image to the user every time the user “walks into” a stamp.

### Treasure Hunt Clues

This type of prize requires the user to find, follow and solve a series of clues in order to locate a prize. Clues can be placed at selected prize points and can be displayed with an ad every time they are walked into. Clues, when collected, can be put into the user's stamp album for instant future reference. If desired, Clues can be configured so that they must be collected in the correct sequence. To place a treasure hunt prize, the client can write a number of clues and place them at their chosen locations on the DreamWalk map. Each clue can be a hint as to where to find the next clue. Once a user collects all of the clues in the campaign, they are entitled to a prize (or a chance at winning a prize, such as a sweepstake entry).

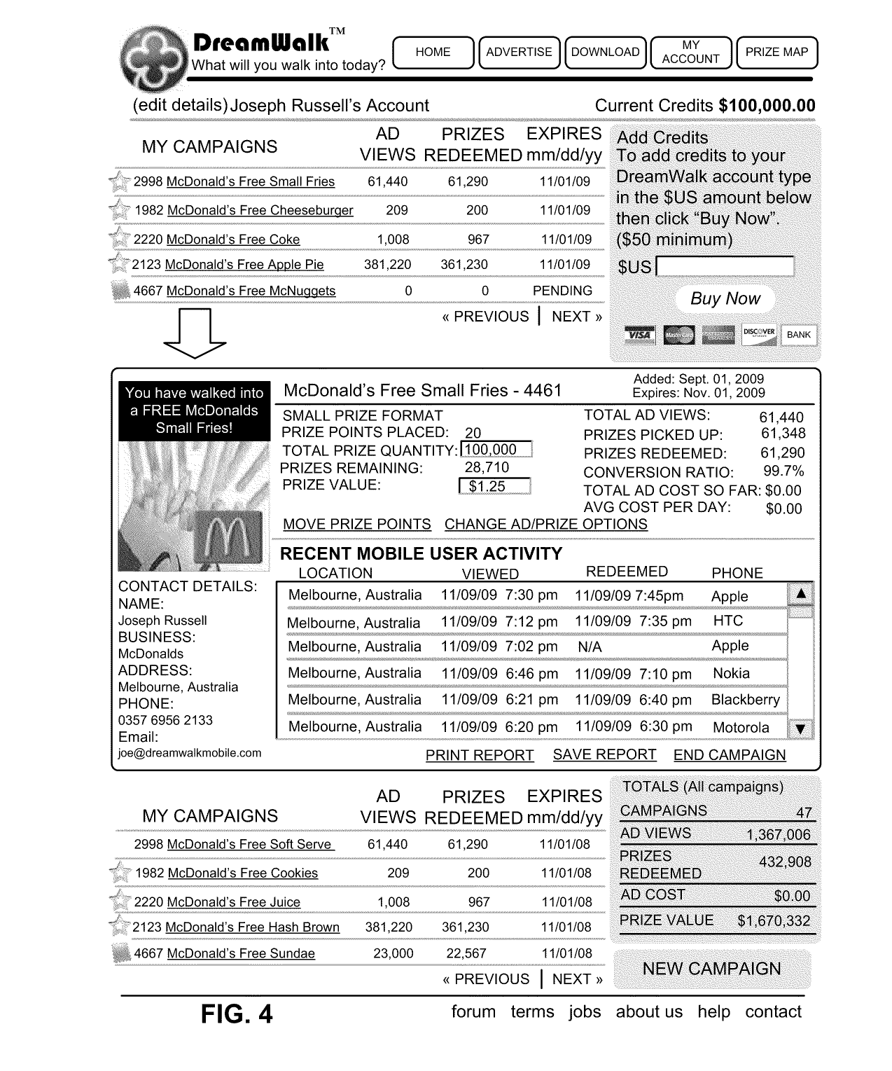

Clients can upload as many prizes as they want to the DreamWalk Map and they can keep track of them via their “My account” page on the website. For example, as shown in FIG. 4, at the “My account” page clients can see how many of their prizes have been picked up and where and when they were picked up as well as other statistics relating to their DreamWalk account.

Referring again to FIG. 2, when uploading a prize, the system can be configured to receive one or more of the following non-exclusive list of details and options.

Business Name—The name of the client.

Campaign Name—The name of an advertising campaign. This can be a promotional name or a reference name, which is only viewable by the client.

Contact Name—A contact person that is associated with the client.

Contact Email—An email address for the contact person.

Contact Phone—A telephone or cell phone number for the contact person.

Prize Name—A name of the prize that is to be placed on the map. This name can be a promotional name viewable by the users or it can be reference name that is only viewable by the client.

Prize Value—An indication of the value of the prize can be supplied. That is, the monetary or other value to the user upon collection of the prize.

Total Prize Quantity—How many prizes they wish to give away in total. For example, the client can select a total number of prizes that can be collected. After this number is reached, the map can remove the prize identification from the DreamWalk map and/or it can otherwise identify to users that this prize is no longer available. For example, if a prize that only has 1 GPS location has a prize quantity of 1,000, then 1000 users can pick up the same prize from that particular location before the prize disappears from the map.

Number of Prize Point Locations—An indication of the number of GPS locations they wish to be associated with their prize. The total prize quantity can be defined as the total prizes per location or a cumulative amount of prizes over all locations.

Upload image—This image is displayed to users every time they walk into the prize point.

Upload Logo—The business logo is displayed with some text when a user clicks on a prize on the map

Campaign expiration date—when they wish their prizes to be deleted from the map.

Prize expiration date—when they wish their unclaimed prizes to be deleted from users prize bags.

Prize Limit—this feature limits how many prizes the business gives away per day.

Per person limit—Limits how many of this particular prize a user can pick up.

Which days of the week the prize is visible—The prize can be available to users (i.e., shown on the map) only during certain days of the week. Thus, for example, if a store is only open on Monday through Friday, it may be desirable to limit collection of a prize for that store on those days.

Redemption Method—An indication of how the prize is redeemed i.e., in store, via SMS, via mail or via download.

Prize Conditions—An indication of any prize conditions that are present, such as, for example, any restrictions on collection and/or redemption of the prize.

Stamp Values—For collector stamp prize format, the business must specify which letters the stamps should contain.

Clues—for Treasure Hunt prize format, the business must type in the clues they wish to display.

An exemplary embodiment of entering a prize or other virtual geographic advertisement will now be described. In a first step, a client can create a DreamWalk account using the web interface. (See, e.g., FIG. 1.) In a second step, the registered client can log into their account and create a ‘prize’ campaign by selecting one of the prize formats available. The prize format relates to how the end user will interact with the prize. (See, e.g., FIG. 2.)

In a third step, the registered client can enter campaign details including (as described in more detail above) business name, contact name, campaign name, prize name, prize value, campaign expiration date, prize expiration date, prize redemption method, user targeting options, promotional codes and conditions. (See, e.g., FIG. 2.)

In a fourth step, the registered client can upload their logo and prize image. The prize image can be an advertisement for their brand or giveaway, a current promotion being run by the client, and/or a graphical representation of the free product they are giving away. (See, e.g., FIG. 2.)

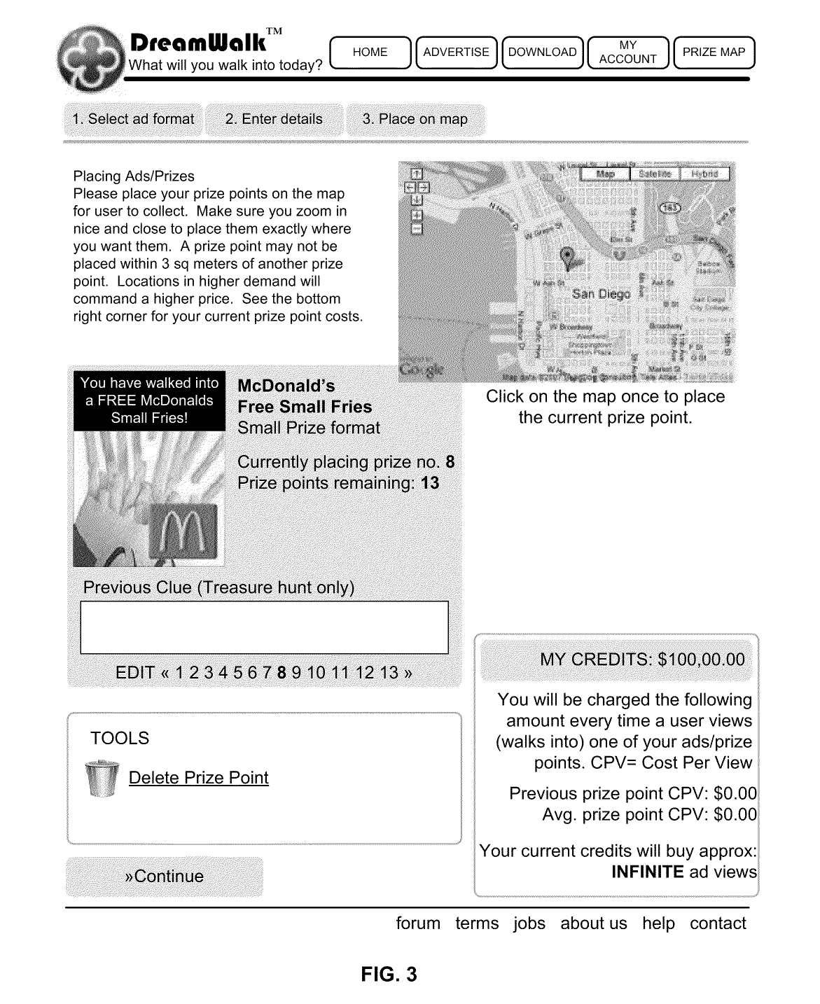

In a fifth step, the registered client can select the locations for their prizes. The identification of the prize location can be achieved in a variety of ways. For example, the client can select a location by clicking on a graphic map interface. (See, e.g., FIG. 3.) This may be a Google Maps based interface, or one from another provider. Alternatively, the client can enter the location by entering in a street address, cross streets, neighborhood, GPS coordinates, or other geographic location determining information. If desired, a radius can be selected to determine how near to the selected geographic location the user must be in order to receive the prize.

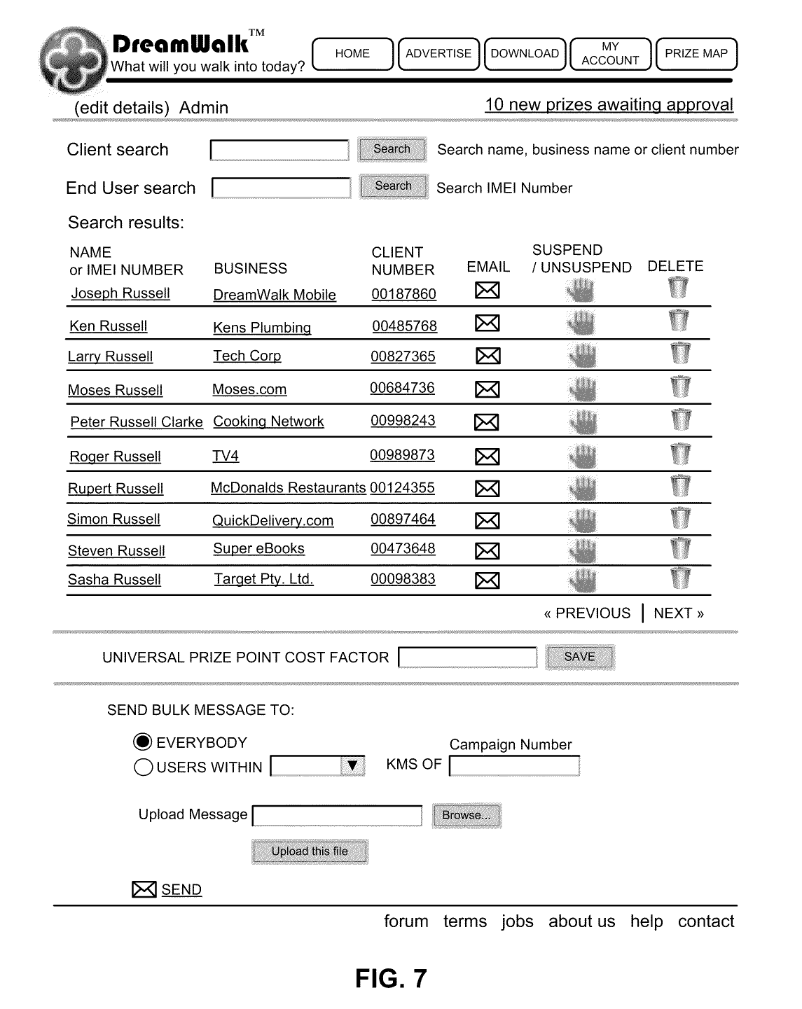

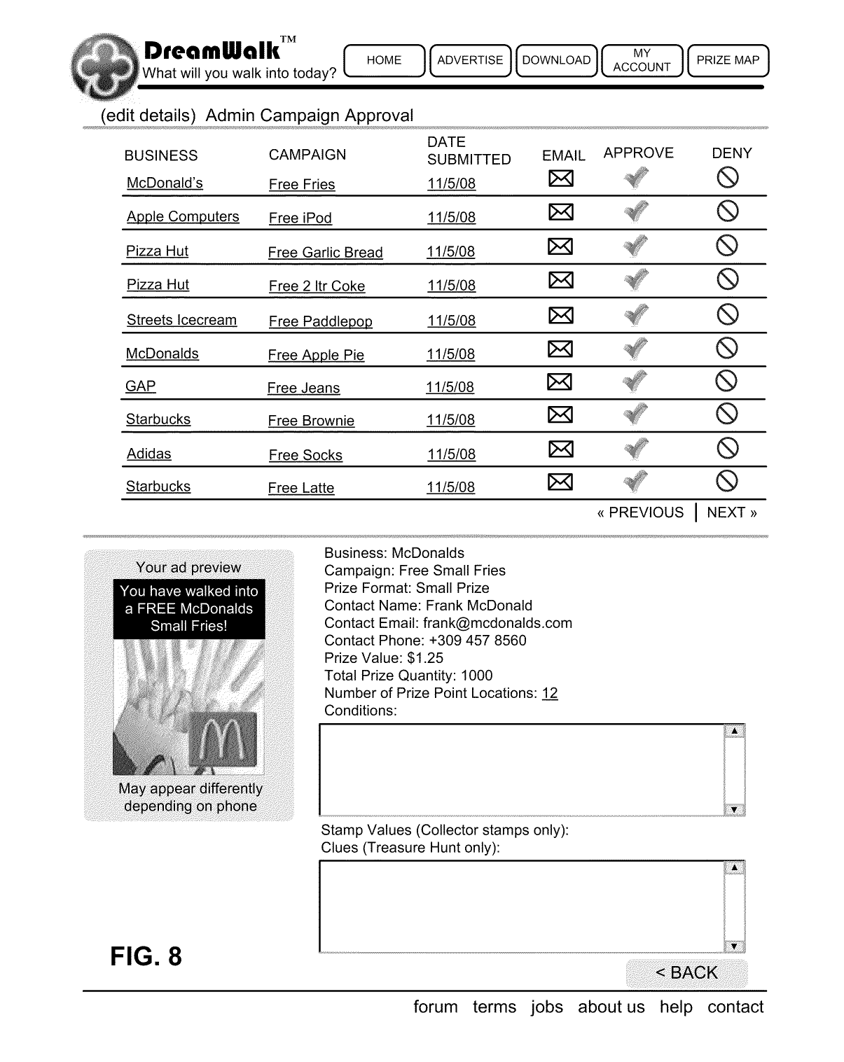

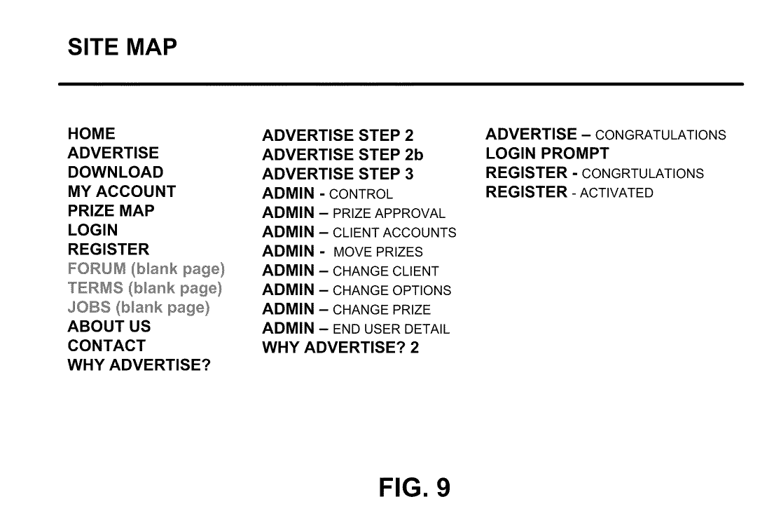

FIGS. 7 and 8 illustrate administration tools for reviewing accounts of clients and/or users. As shown in FIG. 7, various client accounts can be searched, displayed, suspended, unsuspended, and/or deleted by the DreamWalk administration.

In one embodiment, shown in FIG. 8, some or all prizes that are added to the map must be approved by DreamWalk administration before they are visible on the map. If desired, this approval process can be limited to new advertisers or to a limited subset of existing advertisers. In addition, the system can be configured so that administration can also delete prizes and change prize options and details in the client account. Of course, prize campaigns can also be added by DreamWalk administration staff using the same process as stated above without the requirement of opening a client account.

Once all of the details, images and locations have been selected and uploaded, the DreamWalk application can store the information in a database on the server. If required, these details are then sent to a DreamWalk administration for approval. As shown in FIG. 8, a prize approval page can permit administration of the system to view and approve (or deny) items before they appear on the map for users to collect.

Once approved, if necessary, a prize campaign can be displayed on the DreamWalk prize map as still or animated icons on the map locations selected. The Prize Map can be viewed using the DreamWalk application for mobile devices or on the DreamWalk website.

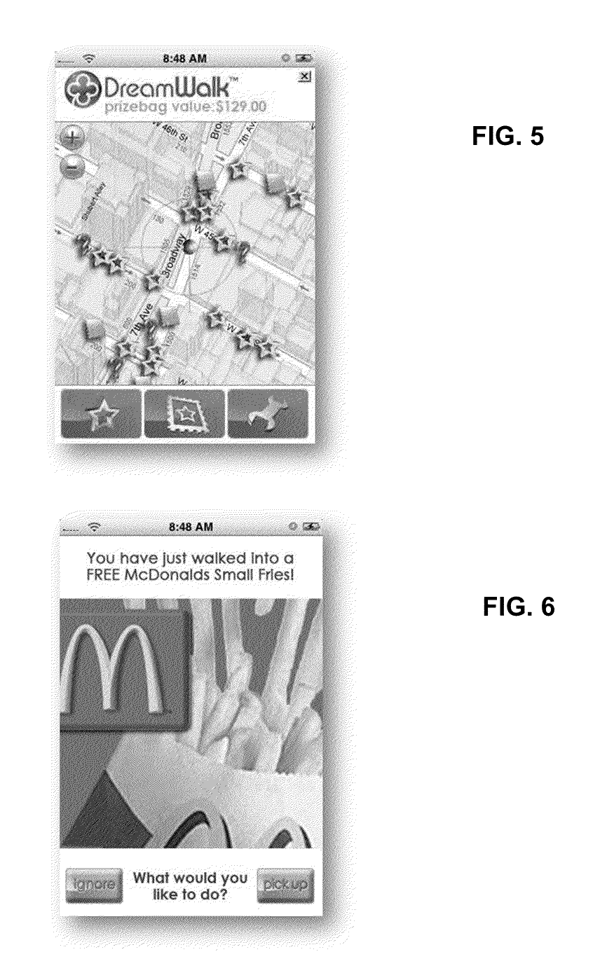

Users of the DreamWalk system (i.e., DreamWalk mobile application users) can explore the prize map freely (see, e.g., FIG. 5) and may click on prize icons to view the prize images, but to collect a prize they must physically move to its GPS location on the prize map. The prize images may include a graphical representation of the prize and/or a description of the prize being offered by the client.

The GPS location information associated with the position of the mobile device can be sent to a DreamWalk application and server from the mobile device handset's built in GPS chip (or another method of obtaining its position such as triangulation). This information can then be compared with GPS location information for prizes stored on the DreamWalk server.

When the user gets close enough to the GPS location of a prize (as determined by the preselected/predetermined radius described above), the prize image for that prize is displayed on their mobile device screen and they are asked if they would like to “pick up” the prize. (See, e.g., FIG. 6 or FIG. 10B.) If they choose not to pick it up, the prize will remain on the prize map for others to collect. If the user chooses to pick the prize up, it will be added to the users ‘prize bag’ or ‘stamp album’ for later redemption. (See, e.g., FIG. 10C.)

A user can redeem a prize they have collected in any way specified by the client (e.g., by email, in-store, via web link, or by SMS). Prizes can be redeemed in various ways and the manner of redemption can be specified by the client who placed the prize. For example, prizes can be redeemed:

In store: This method requires the mobile user to go into a store or venue to redeem their prize. Once inside they must show the staff the prize on their mobile screen. In some embodiments, the prize can be represented and/or identified by a promo code and/or a bar code that can be displayed on the user's mobile device.

Via email: The user (or the DreamWalk system) can send an automated email to the applicable business containing contact details and promo code. This information can be sent directly by the DreamWalk application (on the mobile device) or through the DreamWalk system. If the prize is a free product or coupon that will be sent directly to the user (e.g., via mail or e-mail) the email can contain the user's contact details so the client can send the user the free product or coupon.

Via other digital transfer means: DreamWalk can open the users SMS application or other electronic transfer means (e.g., such as IR transfer) and allows the user to send an SMS or other such message to the applicable business containing contact details and promo code. When using this method, DreamWalk can send a text message to the client every time a mobile user redeems one of their prizes. If necessary, the message can contain the user's contact details so the client can send them the free product.

Via download: Digital files can be redeemed via a web link that redirects the user to a download page in their mobile web browser where they can download the prize. This method is particularly suitable for digital prizes such as MP3s, ebooks or web subscriptions. This method may require the client to have a website that is optimized for delivery of information to mobile devices. When a user redeems the prize they can be transferred to the client's mobile website where they can then download the prize.

Various payment methods can be used to add credits or make payments. For example, PayPal payment processing can be required for clients to add credits to their account. Clients can be charged for the DreamWalk service in a variety of manners, including, for example, upon placement of the ad/prize on the DreamWalk website, upon “discovery” of a prize by a user (e.g., every time someone walks into their prizes).

The amount of the charge can depend on the popularity of the prize location. For example, this cost could be calculated by multiplying the number of prizes nearby (within 30 square meters of the prize) by the “Universal prize point cost factor” as set by administration in the administration control page. See, e.g., FIG. 7.

Referring to FIGS. 10A-10C, an embodiment of an application (e.g., a DreamWalk mobile application) that can run on a mobile phone in accordance with the systems and methods described herein is provided. As shown in FIG. 10A, a map can use GPS (or other locational software) to identify the location of prizes. As shown in FIG. 10B, users running the DreamWalk mobile application can be alerted when they enter the vicinity of a prize. The alert can include an option to pick up the prize or ignore it. When picked up, a prize can be stored in their “prize bag” for later redemption. An exemplary prize bag is shown in FIG. 10C.

iPhone Specific Applications

Various mobile devices are suitable for use with the DreamWalk system. In one embodiment, an application is optimized for use with Apple's iPhone. The iPhone Application can comprise four main parts: a Map, a prize bag, a stamp album and an options page.

As shown in FIG. 10A, the map page can be a map (such as a Google map) with prizes on it. Users can explore the map to find prizes but they must physically move to the GPS location of a prize to collect it.

A Prize bag, as shown in FIG. 10C, can be used to store prizes after the user collects them. This information can be saved and retrieved from the server.

A Stamp Album, as shown in FIG. 10D, can be used to store Collector Stamp and Treasure Hunt format prizes as the user collects them. This information can be saved and retrieved from the server.

A Settings page, as shown in FIG. 10E, can permit the user to customize their DreamWalk experience with various settings. For example, the Settings page can allow customization of or access to the following settings:

About you—allows user to send information to server including name, age, email etc.

Advertise on DreamWalk—Opens web browser and takes user to DreamWalk website.

Help—views help file

SFX on or off—turns sound effects on or off, as desired by the user.

Terms of Use—views terms

FIG. 10F illustrates a sample iPhone screen shot that can be shown to inform the user when the DreamWalk application is running or opened on the iPhone. This screen can be animated if desired.

After the user has collected one or more prizes, those prizes are stored in a prize bag which can be opened and viewed at any time by the user. The user also can have the option to delete any prize from the prize bag, or select them for redemption. Collector stamps and Treasure hunt clues that are stored in the stamp album can be opened and viewed at any time. Once every stamp or clue for a particular prize has been collected the prize can be transferred to the prize bag where it can be deleted or redeemed.

Preferably, the system includes various sound effects that can be triggered by certain events such as walking into a prize (i.e., moving with the mobile device into the geographic region or area associated with the prize). Such sound effects can be supplied in low fidelity for small file size. The application can be used via the DreamWalk application interface or can be set to run in the background and alert the user when they walk into prizes.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A system for delivering a prize to a mobile device, the system comprising:
a registration interface for registering a plurality of mobile devices with the system;
a registration interface for registering a plurality of clients with the system;
a prize designation interface through which each of the plurality of clients can designate one or more prizes, each prize being associated with a specific geographic location;
a geographic location receiving device configured to receive information relating to the geographic location of the registered mobile devices; and
a delivery device for delivering the prize to one of the registered mobile devices when that mobile device is located within a predetermined radius of the specific geographic location associated with the delivered prize.

2. The system of claim 1, wherein the prize comprises a redeemable prize that can be exchanged for an item of monetary value.

3. The system of claim 2, wherein the delivery of the prize comprises the delivery of information that can be displayed on the registered mobile device, and wherein the displayable information can be presented on a display of the mobile device to receive the item of monetary value.

4. The system of claim 1, wherein the prize can comprise electronic information that can be downloaded to the registered mobile device.

5. The system of claim 1, wherein the prize can comprise electronic information that can be delivered to the registered mobile device via a text message or email.

6. The system of claim 1, wherein the plurality of clients can designate one or more collection prize, wherein a plurality of prizes must be delivered to one registered mobile device prior to receiving a collection prize.

7. The system of claim 6, wherein the delivery of the collection prize comprises the delivery of information that can be displayed on the registered mobile device, and wherein the displayable information can be presented on a display of the mobile device to receive an item of monetary value associated with the collection prize.

8. The system of claim 6, wherein the collection prize can comprise electronic information that can be downloaded to the registered mobile device.

9. The system of claim 6, wherein the collection prize can comprise electronic information that can be delivered to the registered mobile device via a text message or email.

10. The system of claim 6, wherein the collection prize comprises a collection of stamp prizes.

11. The system of claim 6, wherein the collection prize comprises a collection of treasure hunt prizes.

12. The system of claim 1, wherein the location of the plurality of registered mobile devices are determined using global positioning system information.

13. A method for delivering a redeemable prize to a mobile device using a prize delivery system, the method comprising:
registering a plurality of mobile devices with the system;
registering a plurality of clients with the system;
associating a plurality of redeemable prizes with one or more clients, each redeemable prize being associated with a specific geographic location;
determining when a registered mobile device is within a predetermined radius of the specific geographic location associated with one or more of the redeemable prizes; and
delivering the redeemable prize associated with the specific geographic location when the registered mobile device is within the predetermined radius of the specific geographic location associated with that redeemable prize.

14. The method of claim 13, further comprising delivering map information to the plurality of mobile devices, the map information delivered to each mobile device comprising specific geographic location of at least some of the redeemable prizes.

15. The method of claim 14, the map information comprises graphical icons that are representative of the redeemable prizes.

16. A computer-readable storage medium storing computer-executable instructions for causing a computer to perform a method for delivering a redeemable prize to a mobile device using a prize delivery system, the method comprising:
registering a plurality of mobile devices with the system;
registering a plurality of clients with the system;
associating a plurality of redeemable prizes with one or more clients, each redeemable prize being associated with a specific geographic location;
delivering map information for display on the registered mobile devices, the map information comprising a plurality of graphical depictions that are representative of the plurality of redeemable prizes;
determining when a registered mobile device is within a predetermined radius of the specific geographic location associated with one or more of the redeemable prizes; and
delivering the redeemable prize associated with the specific geographic location when the registered mobile device is within the predetermined radius of the specific geographic location associated with that redeemable prize.

17. The method of claim 16, further comprising storing redeemable prizes that have been delivered to the registered mobile devices.

18. The method of claim 16, further comprising limiting the number of prizes associated with one client and one specific geographic location based on a predetermined number of prizes.

19. The method of claim 16, wherein one or more of the redeemable prizes comprise collector stamps that can be collected to receive a collection prize, the collection prize being delivered to one registered mobile device after delivering of each collector stamp associated with the collection prize.

20. The method of claim 16, further comprising the step of reviewing each of the redeemable prizes for approval prior to delivering map information associated with the redeemable prizes.
